(19) United States
(12) Patent Application Publication
(10) Pub. No.: US 2011/0092627 A1
(43) Pub. Date: Apr. 21, 2011

(54) POLYESTER RESIN COMPOSITION COMPRISING AN ANTIMONY DOPED TIN OXIDE

(76) Inventor: Zo-Chun JEN, Taipei (TW)

(21) Appl. No.: 12/580,394

(22) Filed: Oct. 16, 2009

(51) Int. Cl. C08K 3/22

(52) U.S. Cl. 524/410

(57) ABSTRACT

The present invention relates to a polyester resin composition comprising an antimony doped tin oxide for the polyester bottle manufacture, wherein 5˜10,000 ppm of the antimony doped tin oxide particles with a particle diameter of 0.005˜10 μm is added to a polyester base resin. The polyester resin composition comprising a blue antimony doped tin oxide can not only improve the infrared absorbance capability of polyester parisons, but also provide polyester bottles with a better coloration.

### TECHNICAL FIELD

The present invention relates to a process for producing polyester bottles, especially relates to bottles made of a packaging grade polyester resin composition. In more detail, the present invention relates to a polyester resin composition comprising an “Antimony Doped Tin Oxide” (hereunder abbreviated as ATO) particle as an additive to absorb infra-red radiation. Using the ATO incorporated polyester resin composition, not only the infra-red radiation absorbance of the polyester parison is improved, but also the coloration L-value of polyester resin composition pellets is lowered to a less extent.

### BACKGROUND ART

Polyester, especially “polyethylene terephthalate” (hereunder abbreviated as PET), is a packaging grade chemical polymer generally suitable for making bottles. Because the bottles made from the said polymer show outstanding mechanical strength, transparency and chemical resistance. To make polyester bottles, the polymer is cut into polyester pellets, the resulting polyester pellets are processed into parisons through an injection molding technique, then the PET parisons are heated to a specific temperature above the glass transition temperature with infrared heating, finally the PET parisons are stretch-blow molded into bottles with a desired shape.

Generally speaking, a quartz infrared lamp is used to heat PET parisons to a specific temperature above the glass transition temperature in the industry, but the infrared absorbance of PET parisons is poor. The arts to improve the infrared absorbance capability of PET are disclosed in various patents, such as:

In U.S. Pat. No.4,408,004, channel black or furnace black is used as an infrared (radiation) absorbance particle. A PET parison containing 0.1˜10 ppm of carbon black with a particle diameter of 10˜500 nm shows a less time necessary to be heated to a desired temperature.

In U.S. Pat. No. 5,529,744, it is disclosed that a reducing agent (phospherus acid with 3-valence) is added to react with the antimony catalyst for PET polymerization, then 3-valence antimony is reduced into grey antimony metal. Resulting grey antimony metal is used as infrared absorbance particles.

In U.S. Pat. No. 6,034,167, graphite is added as an infrared absorbance particle. The particle diameter of the graphite used is 0.1˜20 μm, and the concentration thereof is 0.1˜15 ppm.

In U.S. Pat. No. 6,503,586, an inorganic black particle is incorporated as infrared absorbance particles. As disclosed in the said patent, the inorganic black particle is copper chromite spinels, its particle size is 0.5˜200 μm, and its concentration is 3˜170 ppm.

In U.S. Pat. No. 6,022,920, a black iron oxide (ferroferric oxide: Fe₃O₄) is applied as infrared absorbance particles. The particle diameter of the black iron oxide used is 0.1˜10 μm, and its concentration is 5˜50 ppm.

In United States Patent Application No. 2006-105129, Titanium carbide (TiC) is incorporated as an infrared absorbance particle. The particle diameter of the Titanium carbide used is 0.005˜100 μm, and the concentration thereof is 0.5˜1000 ppm.

In all of the above mentioned patents, black or grey inert particles are added in PET. But the polyester resin composition obtained from adding black or grey inert particles in PET will give the PET bottle a darker color, thereby the customers may not accept the product.

### SUMMARY OF INVENTION

In consideration of the above mentioned problem, an object of the present invention is to provide a non-black or non-grey inert particle, i.e. a blue ATO particle containing polyester resin composition to improve the infrared absorbance capability of the PET parison. The polyester resin composition with addition of such blue ATO particles gives the PET pellet a coloration L-value lower to a less extent and the PET pellet still can keep a high infrared absorbance capability.

Another object of the present invention is to provide a polyester resin composition comprising an antimony doped tin oxide for the polyester bottle manufacture, wherein 5˜10,000 ppm of the antimony doped tin oxide particles with a particle diameter of 0.005˜10 μm is added to a polyester base resin. The polyester resin composition comprising a blue antimony doped tin oxide can not only improve the infrared absorbance capability of polyester parisons, but also provide polyester bottles with a better coloration.

### DISCLOSURE OF INVENTION

As well known in the industry, for heating a PET parison to produce a PET bottle, a quartz infrared lamp is used to heat the PET parison to a temperature which allows the parison to be blow-molded, thus the PET parison can be stretch-blow-molded into a bottle with a desired shape. The wave length for the quartz infrared lamp to exhibit the maximum radiation energy is in the range of 1100˜1200 nm. The purpose of the PET parison exposing to the heating of a quartz infrared lamp is that infrared can penetrate into the interior of the PET parison in the form of radiation to get a homogeneous resonance heating and result in a uniform warming of the whole PET parison. The even heating of the bottle parison is important, if the

PET parison is unevenly heated, when the PET parison is stretch-blow-molded, it will result in an undesired hazy crystallization.

As revealed in the literature-Polymer 43(2002), PP1835˜1847, the infrared wave lengths which PET can absorb are 5800 nm(1720 cm-1), 7900 nm(1270 cm-1), 8500 nm(1175 cm-1), 8900 nm(1120 cm-1) and 9800 nm(1020 cm-1); wherein 5800 nm(1720 cm-1) corresponds to the absorbance of the functional group C═O in PET, 7900 nm(1270 cm-1) represents C(O)—O of PET, while 8500 nm(1175 cm-1), 8900 nm(1120 cm-1) and 9800 nm(1020 cm-1) belongs to the resonance absorbance of the benzene ring in PET. The said functional group C═O means C═O in a keto group, and C(O)—O functional group is O—C═O in an ester group. As described above, the PET structure itself shows a better absorbance capability only to the wave length range of far infrared. The quartz lamp exhibits the maximum radiation energy in the wave length range of about 1100˜1200 nm, which belongs to a near infrared, since the wave length of the near infrared covers 800 nm˜2500 nm, the absorbance of PET in the near infrared range of 1100˜1200 nm is poor.

WO No. 2004/036978 illustrates an ATO containing resin can be processed to obtain a good thermo-insulation material for agricultural facilities. As further shown in the said patent, the insulation material made of an ATO containing resin can transit the visual light of 380 nm—780 nm which is necessary for the growing of the plant, and can shade the near infrared irradiation of 780 nm˜2100 nm to carry out the effect of thermo-insulation. As known from the present invention, ATO is a good material to absorb near infrared, but up to now, no patents or literatures relate to ATO as an additive for improving the infrared absorbance capability of the PET parison.

To improve the infrared absorbance capability of the PET parison, i.e. to elevate the PET absorbance on the near infrared of 1100˜1200 nm, as disclosed in the previous mentioned United States Patents, back or grey inert particles are incorporated in PET to increase the infrared absorbance capability of the PET parison. The polyester resin composition obtained from adding black or grey inert particles in PET will absorb visible light in addition to infrared, but it give the PET bottle a darker color, thereby the customers do not accept the product. While the PET parison with addition of ATO as infrared absorbance particles can not only absorb near infrared of 780 nm˜2100 nm to raise the infrared absorbance of the PET parison, but also can transit visible light of 380 nm˜780 nm, thus PET bottles made of the ATO containing polyester resin show a color closer to a neutral one.

ATO is widely used in the field of display panel, solar cell and electrode materials etc., but not yet utilized in PET bottles. According to the present invention, using ATO as infrared absorbance particles can elevate the infrared radiation absorbance capability of the PET parison, can simultaneously lead to PET bottles of good color.

The method to produce ATO particles includes gelatination, atomization pyrolysis, metal alcoholate hydrolysis and chemical co-precipitation. Any method can be used in the preparation of ATO of the present invention without restriction, the molar ratio of antimony/tin (Sb/Sn) in the particle is 1˜20%, the particle diameter is 0.005˜10 μm, the additive to be added in polyester to obtain the polyester composition is 5˜10,000 ppm. The blue ATO particle incorporated polyester resin composition provides PET pellet L-value decrease to a less extent, and the resulting PET parison still keeps a good infrared absorbance.

Based on the present invention, when the PET pellet prepared from an ATO particle incorporated polyester resin composition keeps coloration L-value(ΔL) change to a less extent, a PET parison made of the said PET pellet can still achieve a higher temperature raising (ΔT), in other words, the ratio of ΔT/ΔL is higher. ΔL is based on the PET pellet without any infrared absorbance particle, while ΔT is also relative to the PET pellet without any infrared absorbance particle. The ΔT/ΔL ratio of ATO added polyester is larger than 2. In the following comparative examples, the ΔT/ΔL ratio of polyester including black ferroferric oxide(Fe₃O₄) with an average particle size of 0.3 μm is 1.55, and that of polyester containing carbon black with an average particle size of 0.5 μm is 1.25.

A variety of polyester resin compositions can be employed in the present invention, polyester resins can be generally produced from the esterification of a diacid and a diol, or the trans-esterification of a diester and a diol, e.g. the trans-esterification and polymerization of DMT and a diol. The most widely used diacid is terephthalic acid (TPA), and the most widely used diol is ethylene glycol (EG). Polyester can be made from two or more kinds of diacids or diols.

The suitable acids for the production of polyester can be chosen from the group including iso-phthalic acid, succinic acid, glutaric acid, adipic acid, sebacic acid or the mixture thereof. The suitable alcohol for the production of polyester can be chosen from the group including diethylene glycol, 1,3-propanediol, 1,4-butanediol or the mixture thereof.

The polyester manufacture process is well known in the industry, generally terephthalic acid and ethylene glycol react at the temperature of 210˜270° C. to obtain monomer and water. The resulting water is continuously removed to let the reaction run forward smoothly. The catalyst is not necessary in the period of reaction, although the catalyst can slightly fasten the reaction, it will increase the formation of diethylene glycol (DEG) as a byproduct which will deteriorate the product quality. The polycondensation reaction includes a prepolymerization and a main polymerization, wherein the prepolymerization conditions comprise a temperature in the range of 270˜280° C. and a vacuum of 250˜15 mmHg; and as for the main polymerization, the reaction temperature of is in the range of 275˜285° C., the vacuum is a high degree vacuum lower than 1 mmHg.

The intrinsic viscosity (IV) of PET polymer at the end of PET melt polycondensation rises to 0.5˜0.7 dl/g, the resulting polymer is removed and quenched in cooling water, then it is cut into polyester pellets in a column shape.

In order to raising the intrinsic viscosity to the level of a bottle grade, polyester pellets are further conducted a solid phase polymerization to increase the value of IV to 0.70˜1.1 dl/g, preferably to 0.72˜0.88 dl/g.

If the temperature of the solid phase polymerization is below 200° C., the elevation of IV will be slow, even no solid polymerization occurs.

The analysis method of the above mentioned intrinsic viscosity (IV) is carried out with an Ubelohde viscometer at the temperature of 25° C. in a solvent mixture of phenol and tetrachloroethane in the weight ratio of 3:2.

The manufacture of polyester beverage containers and other transparent polyester bottles includes at first polyester pellets are crystallized and dried, then they are injection-blow molded into parisons with an injection-blow molding machine, thereafter the resulting parisons are heated to a specific temperature, and stretch-blow molded into bottles in a desired shape.

The catalysts used in the condensation of the invention are antimony acetate, antimony trioxide, titanium tetra-n-butoxide or the mixture thereof. Stabilizers can be phosphoric acid, phosphorous acid, trimethyl phosphate, triphenyl phosphate or triethyl phosphate, etc.

In accordance with the present invention, as long as the transparency is not influenced, a variety of additives as follows can be incorporated in the polyester composition: thermo-stabilizer, photo-stabilizer, dye, pigment, plasticizer, antioxidant and ultra-violet absorber etc.

In the procedure of the polyester preparation of the invention, ATO particles can be fed at any time during the mixing of diacid and diol, or in the period of esterification or polycondensation. The additive of ATO is in the range 5˜10,000 ppm, most preferably 10˜500 ppm. The particle size thereof is 0.005˜10 μm, most preferably 0.01˜5 μm. The blue ATO particles included polyester resin composition not only shows less color L value decrease for the PET pellet, but also allow the PET parison to keep a superior infrared absorbance capability. The PET polyester pellet color (expressed by the values of L/a/b) can be measured with Spectrophoto Meter (TC-1800MKII made by TOKYO DENSHOKU CO., LTD). The higher the L-value determined, the whiter the polyester pellets exhibit; on the contrary, the lower the L-value, the darker the polyester pellets show. The higher the a-value, the redder the polyester pellets present; the lower the a-value, the greener the pellets display. Finally the higher the b-value, the yellower the pellets come out, while the lower the b-value, the bluer.

### EXAMPLES

### Example 1

12.11 Kg of PET oligomer and 3.87 Kg of ethylene glycol (EG) are added in a 30 liter stainless steel reactor, stirred and heated to 260° C. under atmosphere pressure, the resulting 1.3˜1.6 Kg of an ethylene glycol distillate is discarded. Before the proceeding of polycondensation reaction, 100 ppm of orthophosphoric acid, 450 ppm of antimony acetate as a polycondensation catalyst, 100 ppm of cobalt acetate and 50 ppm of ATO with a mean particle diameter of 0.05 μm are added in sequence, wherein the molar ratio of antimony to tin (Sb/Sn) is 5%.

Then the reactor is vacuumized to a pressure below 1 mmHg, the prepolymerization is conducted at the temperature of 270° C., and the main polymerization takes place at 280° C., thereby 11.47 kg of copolyester is obtained. The intrinsic viscosity of the resulting copolyester is in the range of 0.6˜0.64dl/g.

The aforementioned polymer obtained is pelletized, then dried and crystallized under the atmosphere of nitrogen gas at a temperature below 180° C. for 6 hours, thereafter a solid phase polycondensation reaction is carried out at a polycondensation temperature of 225° C. for a reaction time of 20 hours, and upon completion of the reaction, the intrinsic viscosity is in the range of 0.72˜0.82 dl/g. The coloration values L/a/b of polyester pellets are 76.9/−1.7/2.3.

After the end of solid phase polycondensation, the polyester pellets are subjected to injection molding at 280° C. with an injection machine to become polyester bottle parisons, then the resulting parisons are heated in a blow molding machine (KRUPP CORPOPLAST LB 01 E) with a heating power rate of 82% for 19.3 seconds to conduct an infrared heating. The temperature of the heated bottle parison is tested to be 115° C.

### Example 2

In the same manner as in Example 1, except that the additive of ATO (mean particle diameter 0.05 μm, molar ratio of antimony to tin (Sb/Sn) 5%) changes to be 100 ppm. The coloration of the resulting solid polyester pellets is L/a/b=75.4/−1.6/2.0. The polyester pellets are subjected to injection molding with an injection machine to become polyester bottle parisons, then the parisons obtained are heated in a blow molding machine (KRUPP

CORPOPLAST LB 01 E) with a heating power rate of 82% for 19.3 seconds to conduct an infrared heating. The temperature of the heated bottle parison is determined to be 118° C.

### Example 3

In the same manner as in Example 1, except that the additive of ATO (mean particle diameter 0.05 μm, molar ratio of antimony to tin (Sb/Sn) 5%) is doubled to be 200 ppm. The coloration of the resulting solid polyester pellets is Li/a/b=72.7/−1.7/1.7. The polyester pellets are subjected to injection molding with an injection machine to become polyester bottle parisons, then the parisons obtained are heated in a blow molding machine (KRUPP CORPOPLAST LB 01 E) with a heating power rate of 82% for 19.3 seconds to conduct an infrared heating. The temperature of the heated bottle parison is measured to be 124° C.

### Comparative Example 1

Following the steps of Example 1, the only difference is that the infrared absorbance particle is changed to be black ferroferric oxide with a mean particle diameter of 0.3 μm and a concentration of 32.5 ppm. The coloration of the resulting solid polyester pellets is L/a/b=69.6/−1.0/−1.2. The polyester pellets are subjected to injection molding with an injection machine to become polyester bottle parisons, then the parisons obtained are heated in a blow molding machine (KRUPP CORPOPLAST LB 01 E) with a heating power rate of 82% for 19.3 seconds to conduct an infrared heating. The temperature of the heated bottle parison is tested to be 123° C.

### Comparative Example 2

Following the steps of Example 1, except that the infrared absorbance particle is changed to be carbon black with a mean particle diameter of 0.5 μm and a concentration of 4.5 ppm. The coloration of the resulting solid polyester pellets is L/a/b=71.6/−1.1/−1.2. The polyester pellets are subjected to injection molding with an injection machine to become polyester bottle parisons, then the parisons obtained are heated in a blow molding machine (KRUPP CORPOPLAST LB 01 E) with a heating power rate of 82% for 19.3 seconds to conduct an infrared heating. The temperature of the heated bottle parison is tested to be 118° C.

### Comparative Example 3

Following the steps of Example 1, except that no infrared absorbance particle is used. The coloration of the resulting solid polyester pellets is L/a/b=78.0/−1.9/2.5. The polyester pellets are subjected to injection molding with an injection machine to become polyester bottle parisons, then the parisons obtained are heated in a blow molding machine (KRUPP CORPOPLAST LB 01 E) with a heating power rate of 82% for 19.3 seconds to conduct an infrared heating. The temperature of the heated bottle parison is tested to be 110° C.

TABLE 1

| | | Examples | | | | | |
|---|---|---|---|---|---|---|---|
| | | | | | | | Comparative |
| | | Example | Example | Example | Comparative | Comparative | Example 3 as a |
| | | 1 | 2 | 3 | Example 1 | Example 2 | comparison base |
| ATO | | 50 ppm | — | — | — | — | — |
| ATO | | — | 100 ppm | — | — | — | — |
| ATO | | — | — | 200 ppm | — | — | — |
| Fe₃O₄ | | — | — | — | 32.5 ppm | — | — |
| Carbon black | | — | — | — | — | 4.5 ppm | — |
| polyester | L value | 76.9 | 75.4 | 72.7 | 69.6 | 71.6 | 78 |
| pellets | a value | −1.7 | −1.6 | −1.7 | −1.0 | −1.1 | −1.9 |
| coloration | b value | 2.3 | 2.0 | 1.7 | −1.2 | −1.2 | 2.5 |

| | | | | | | |
|---|---|---|---|---|---|---|
| The temperature | 115° C. | 118° C. | 124° C. | 123° C. | 118° C. | 110° C. |
| of the infrared | | | | | | |
| heated bottle | | | | | | |
| parison | | | | | | |
| ^{Δ} T/^{Δ} L | 4.55 | 3.08 | 2.64 | 1.55 | 1.25 | — |

The T/L ratio of each example is calculated using Comparative Example 3 as a comparison base:

T/L ratio of Example 1=(115-110)/(78-76.9)=4.55

T/L ratio of Example 2=(118-110)/(78-75.4)=3.08

T/L ratio of Example 3=(124-110)/(78-72.7)=2.64

T/L ratio of Comparative Example 1=(123-110)/(78-69.6)=1.55

T/L ratio of Comparative Example 2=(118-110)/(78-71.6)=1.25

What is claimed is:

1. A polyester composition comprising an antimony doped tin oxide for the polyester bottle manufacture, characterized in that the composition is formed of polyester incorporated with 5˜10,000 ppm by weight of an antimony doped tin oxide.

2. The polyester composition comprising an antimony doped tin oxide for the polyester bottle manufacture as claimed in claim 1, wherein the particle size of the antimony doped tin oxide is about 0.005˜10 μm.

3. The polyester composition comprising an antimony doped tin oxide for the polyester bottle manufacture as claimed in claim 1, wherein the molar ratio of antimony to tin (Sb/Sn) in the antimony doped tin oxide is 1˜20%.
